(19) United States
(12) Patent Application Publication
(10) Pub. No.: US 2009/0220915 A1
(43) Pub. Date: Sep. 3, 2009

(54) Dental Implanto-Distractor

(76) Inventor: Krystian Kyonov, Wroclaw (PL)

Correspondence Address: COOPER & DUNHAM, LLP, 30 Rockefeller Plaza, 20th Floor, NEW YORK, NY, 10112, US

(21) Appl. No.: 12/226,456

(22) PCT Filed: Apr. 18, 2007
(86) PCT No.: PCT/PL2007/000020

§ 371 Date: Mar. 2, 2009

(30) Foreign Application Priority Data
Apr. 18, 2006 (PL) P.379475
Jun. 7, 2006 (PL) P.377885

(51) Int. Cl. A61C 8/00

(52) U.S. Cl. 433/174

(57) ABSTRACT

The dental implanto-distractor, having throughway body with external and internal threads, wherein a stretching screw (13) is located in a throughway hole (11) in the body (12) with one of the screw's ends being screwed into supporting base (14, 15) the other one is finished with an abutment (13a) for a dental part.

The subject of the invention is a dental implanto-distractor, which can be used in fastening artificial teeth, especially when joined with augmentation of a jawbone of a patient.

Dental implant, know from the Polish patent description no. 182766, consists of a dental bolt with a cover located in a hole placed into a jaw bone of a patient and a supporting element coming out of the hole, while the supporting element consists of a least one flat surface turned outside. The cover is moving inside the hole from a shrunken position to an expanded position and has got internal offset. The head of the screw with its threaded shank rests on the internal offset. It goes as far as the end of the cover and is linked with expanded cone-shaped nut, joined with sides of the cover, while the shank of the screw is combined with an internal threaded part of the expanded nut, and a columnar collar has got at least one flat surface turned inside, which touches the surfaces of the supporting element, preventing the columnar collar from rotation around the dental implant.

The dental implanto-distractor according to the subject invention, is characterised by the following: there is a stretching screw located in a throughway hole in the body. One of the screw's ands is screwed into supporting base, the other one is finished with an abutment for a dental part. Furthermore, threaded shank of the stretching screw is longer than the body itself and the body and supporting base on their externally threaded surfaces have at least one oblong groove located parallely to oblong axis of the body. Moreover, the supporting base is a titanic plate, or more favourably—titanic small balls.

The dental implanto-distractor according to one of the embodiment of the invention is characterised by the following: there is a stretching screw located in a throughway hole in the body. One of the screw's ands is screwed into supporting base, the other one is finished with an abutment for a dental part. Furthermore, the supporting base is in the form of a externally-threaded screw with its curve line being an extension of a curve line of the body. Moreover, the supporting base id combined—in a non-rotary manner—with the body and the supporting base has got a hexagonal seat adjusted to the size of a hexagonal head of the body and has an internal thread for a tightening screw. Furthermore, threaded shank of the stretching screw is longer than the body itself and the body and supporting base on their externally threaded surfaces have at least one oblong groove located parallel to oblong axis of the body and supporting base. Moreover, the supporting base and body are combined—in a non-rotary manner—by prismatic forming of their front surfaces.

In reference to the current state of the art, the dental implanto-distractor according to the invention, having a stretching screw located in a throughway hole in the body with one of the screw's ends screwed into supporting base is a favourable solution as it enables to move the tissue of a jaw bone at a required level and at the same time prevent the dental implanto-distractor from rotation.

The subject of the invention, as it is applied, is shown at the figure:

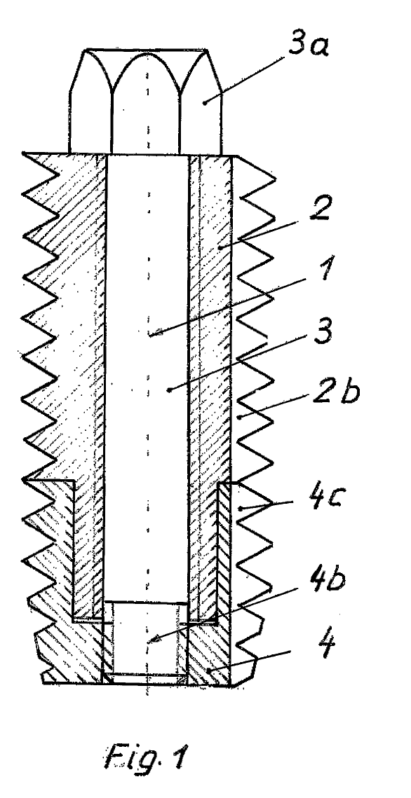

FIG. 1—presenting a dental implanto-distractor in an axial profile, before it is screwed into the hole of jaw bone,

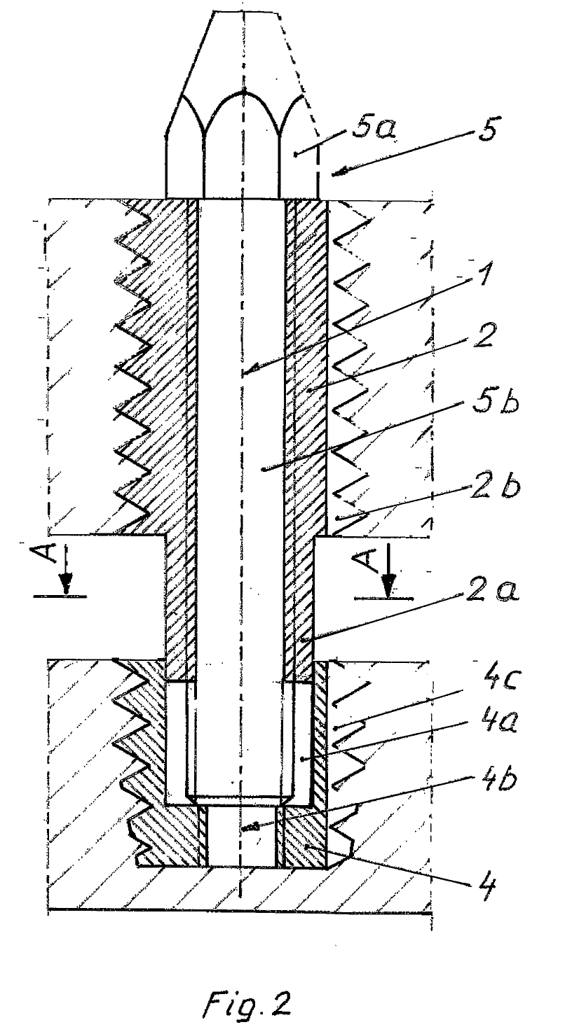

FIG. 2—after the distraction is done,

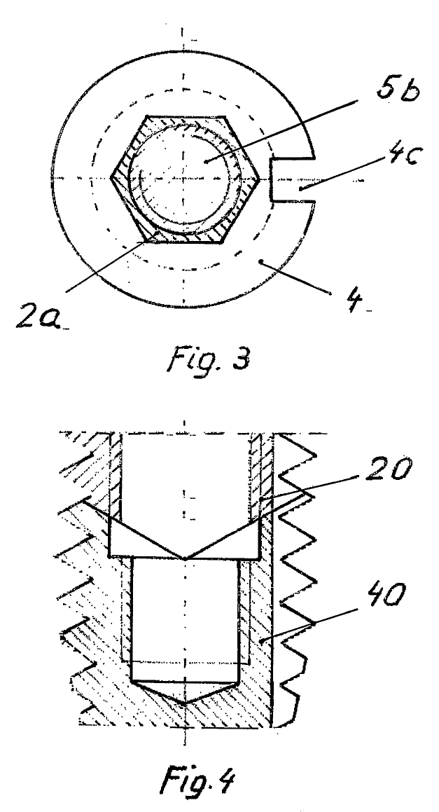

FIG. 3—in an A-A profile,

FIG. 4—prismatic forming of the supporting base and body. Other embodiment of subject of the invention is shown at the next figures:

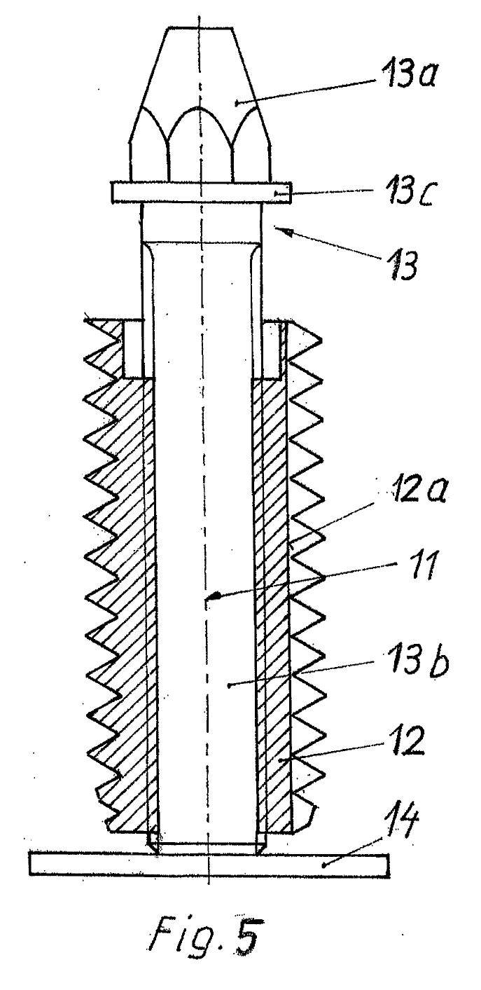

FIG. 5—presenting a dental implanto-distractor in an axial profile,

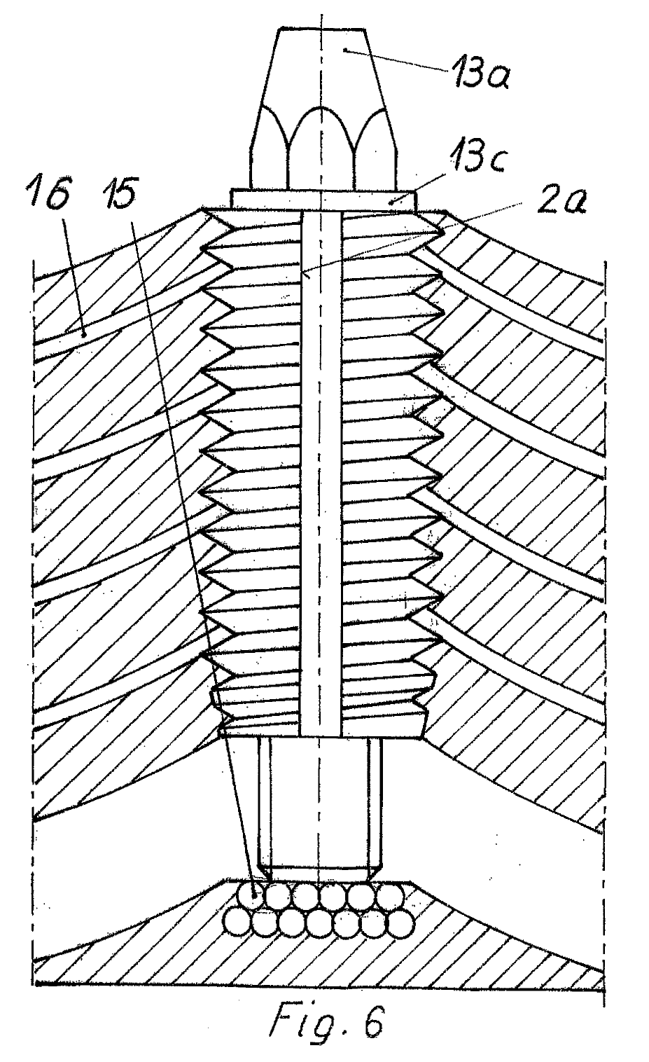

FIG. 6—a dental implanto-distractor with a lifted tissue of a jaw bone.

According to the invention, before the dental implanto-distractor is screwed into the hole in a jaw bone, there is a tightening screw (13) in a throughway hole (11) in the body (12). One of the screw's ends is screwed into supporting base, the other one is finished with an abutment (13a) for a dental element. Threaded shank (13b) of the stretching screw (13) is longer than the body itself (12). The body (12) on its external surfaces must have at least one oblong groove (12b) located parallely to oblong axis of the body (12). The supporting base is a titanic plate (14), or more favourably—titanic small balls (15).

The dental implanto-distractor is used in fastening artificial teeth and augmentation of the tissue of a jawbone of a patient. Therefore a hole, which is not deeper than the length of the body (12) is done in a jaw bone. Oblong slot where the supporting base in the form of a titanic plate is placed is also done. Afterwards the bode (12) together with a blind screw (not shown in the picture) is screwed in the hole of a jaw bone. After removal of the blind screw, the stretching screw (12) is screwed. Sides of the jaw bone is perforated by making slits (16) is order to increase its forming capabilities. Distraction of the jaw bone is performed when the stretching screw (13) is screwed as far as its collar (13c) rests on the head of the body (12). In other version of the solution, before screwing the body (12), titanic small balls (15) is placed in the hole of the bone, in order to make pressures onto the bottom part of the hole favourably spread.

According to other embodiment of the invention, before the dental implanto-distractor is screwed into the hole in a jaw bone, there is a tightening screw (3) in a throughway hole (1) in the body (2). One of the screw's ends is screwed into supporting base (4), the other one is finished with a hexagonal head (3a) for a spanner. After the dental implanto-distractor is screwed into the hole in a jaw bone, there is a stretching screw (5) in a throughway hole (1) in the body (2). One of the screw's ends is screwed into supporting base (4), the other one is finished with an abutment (5a) for a dental element. The supporting base (4) has got a hexagonal seat (4a) adjusted to the size of a hexagonal head (2a) of the body (2) and a hole with an internal thread for a tightening screw (3). Threaded shank (5b) of the stretching screw (5) is longer than the body itself (2). In order to seize the implanto-distractor in the hole of a jaw bone, the body (2) and supporting base (4) on their external surfaces must have at least one oblong groove (2b and 4c) located parallel to oblong axis of the body (2) and supporting base (4). In a somewhat simplified technologically version of the implanto-distractor, the supporting base (4) and body (20) are combined—in a non-rotary manner—by prismatic forming of their front surfaces.

The dental implanto-distractor is used in fastening artificial teeth and augmentation of the tissue of a jawbone of a patient. Therefore a hole, which is not deeper than the length of the body (2) is done in a jaw bone; and afterwards the first unit of the dental implanto-distractor, presented in FIG. 1, is screwed. As a next step, the tightening screw (3) is screwed out and in its place the stretching screw (5) is screwed in. the stretching screw together with the body (2) and supporting base (4) constitute the second unit of the dental implanto-distractor. The distraction of a tooth is performed after jaw bone is weakened through its perforation. At the time the stretching screw rests on the supporting base, is further rotation results in the body lifting and together with—the bone tissue lifting. The height variance between the length of the threaded shank (5b) of the stretching screw (5) and the length of the body (2) is the level at which the bone tissue is lifted.

1. The dental implanto-distractor, having throughway body with external and internal threads, characterised in that, a stretching screw (13) is located in a throughway hole (11) in the body (12) with one of the screw's ends being screwed into supporting base (14, 15) the other one is finished with an abutment (13a) for a dental part.

2. The dental implanto-distractor according to claim 1, characterised in that the threaded shank of the stretching screw (13) is longer than the body (12).

3. The dental implanto-distractor, according to claim 1 characterised in that on external, threaded surfaces of the body there is at least one oblong groove (12a) located parallely to oblong axis of the body (12).

4. The dental implanto-distractor according to claim 1, characterised in that the supporting base is a titanic plate (14).

5. The dental implanto-distractor according to claim 1, characterised in that the supporting base are titanic balls (15).

6. The dental implanto-distractor according to claim 1, characterised in that the supporting base (4, 40) is in the form of a externally-threaded screw with its curve line being an extension of a curve line of the body (2, 20).

7. The dental implanto-distractor according to claim 6, characterised in that the supporting base (4, 4o) is combined—in a non-rotary manner—with the body (2, 2o).

8. The dental implanto-distractor according to claim 7, characterised in that the supporting base (4) has got a hexagonal seat (4a) adjusted to the size of a hexagonal head (2a) of the body (2) and has an internal thread (4b) for a tightening screw (3).

9. The dental implanto-distractor according to claim 6, characterised in that threaded shank (5b) of the stretching screw (5) is longer than the body (2).

10. The dental implanto-distractor according to claim 6, characterised in that the body (2, 2o) and supporting base (4, 4o) on their externally threaded surfaces have at least one oblong groove (2b, 4c) located parallely to oblong axis of the body (2, 2o) and supporting base (4, 4o).

11. The dental implanto-distractor according to claim 6, characterised in that the supporting base (4o) and body (2o) are combined—in a non-rotary manner—by prismatic forming of their front surfaces.

12. The dental implanto-distractor, according to claim characterised in that on external, threaded surfaces of the body there is at least one oblong groove (12a) located parallely to oblong axis of the body (12).
